(19) United States
(12) Patent Application Publication
(10) Pub. No.: US 2006/0195324 A1
(43) Pub. Date: Aug. 31, 2006

(54) Voice input interface

(76) Inventors: Christian Birk, Ulm (DE); Tim Haulick, Blaubeuren (DE); Klaus Linhard, Schelklingen (DE)

Correspondence Address: BRINKS HOFER GILSON & LIONE, P.O. BOX 10395, CHICAGO, IL, 60610, US

(21) Appl. No.: 10/534,764

(22) PCT Filed: Nov. 12, 2003
(86) PCT No.: PCT/EP03/12660

§ 371 Date: Mar. 13, 2006

(30) Foreign Application Priority Data
Nov. 12, 2002 (DE) 102 52 457

(51) Int. Cl. G10L 21/00

(52) U.S. Cl. 704/275

(57) ABSTRACT

A voice input system comprising a stationary central unit (1) and a mobile voice interface (2) which is carried around by the user, e.g. in his clothing, is described. The voice interface (2) is used to acoustically record spoken commands which are transmitted to the central unit (1) over a wireless link after being electronically processed. The voice interface contains two or more microphones (3a, 3b, 3c), which cooperate as a microphone array, thereby making possible a directional characteristic during sound recording and also substantial noise suppression. The central unit (1) contains the components for speech recognition, e.g. a processor system, and interfaces (4a. 4b, 4c) via which external appliances are controlled over a wireless link or by cable.

The invention relates to systems wherein the words spoken by a user are recorded and passed on as a signal. The invention is particularly related to systems wherein functions are triggered or controlled via voice input.

Systems with voice input and voice control are known. For example, for computers inputs via voice—dictation of texts and control commands—are possible. In the medical field there exist appliances which can be controlled by the doctor's voice commands, making things easier during difficult operations. In the area of security, too, devices are employed which e.g. will only open a closed door selectively in response to the voice inputs of authorized persons.

All such systems require a high acoustic quality of the voice input if the speech information or commands are to be recognized. Too great a distance between microphone and the speaker's mouth (too weak an input loudness) is particularly troublesome. A similar situation arises if the voice is directed elsewhere than into the main recording zone of the microphone. A relatively short distance to the microphone can also have an adverse effect. On the one hand this may well cause the recording level to overshoot, on the other the breathing of the speaker may also result in strong acoustic noise (wind noise). A high noise level from the surroundings also always has a very disturbing effect on the recognition accuracy of the voice input system.

To solve these known problems in the case e.g. of computer systems with text input, microphone bows are used, which (usually in conjunction with headphones or earphones) are worn on the user's head. If the bow is properly aligned, the recording microphone is always situated at the same distance from, and near to, the user's mouth, despite head movements. A disadvantage here is the restricted freedom of movement due to the usual cable connection to the computer. Furthermore, there may be noise caused by the movements of the cable. In addition, many people find it uncomfortable to wear headphones or earphones, especially for any length of time.

As an alternative, therefore, stationary microphones, e.g. a desk microphone with a tripod or a microphone which is integrated into the housing (PC, laptop) or which is fixed to the appliance (door frame for security function) are also used. A disadvantage here is that the recording zone is restricted to a certain space in front of the microphone. This requires the user to maintain a definite position, body attitude, speech direction, etc., i.e. there is practically no freedom of movement during voice input.

Starting from this prior art it is the object of the present invention to develop a better system for voice input which substantially overcomes the cited disadvantages and exhibits additional advantages.

This object is achieved for a device with the features of the generic clause of claim 1 by the characterizing features of claim 1. Further details of the invention and the advantages of various embodiments are the subject matter of the features of the subclaims.

The device according to the present invention is described below in the light of a preferred embodiment, reference being made to the diagrams and the reference numerals presented therein.

The figures are as follows:

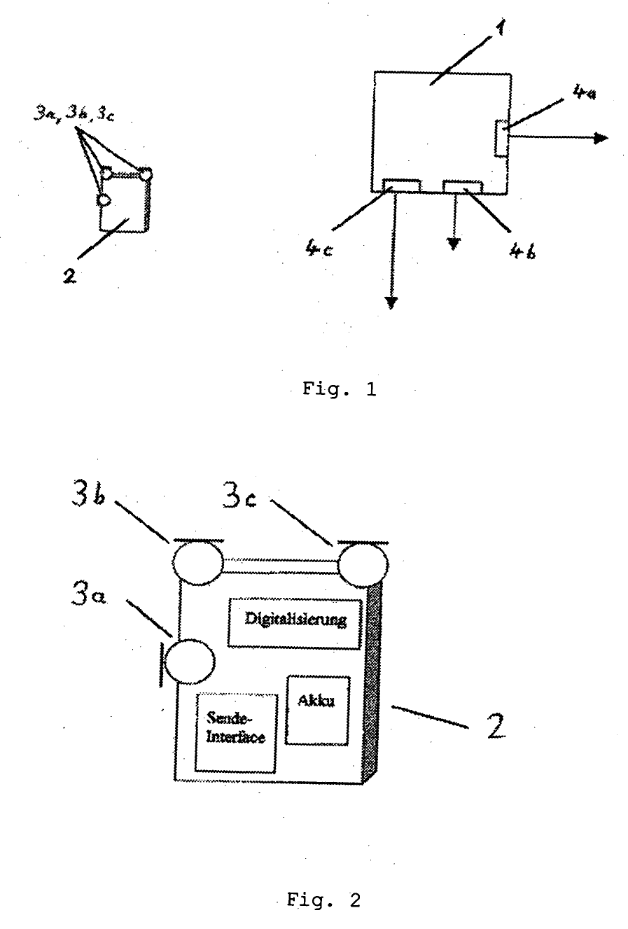

FIG. 1 shows the voice input system according to the present invention, consisting of a central unit and separate voice interface

FIG. 2 shows a schematic representation of one embodiment of the voice interface

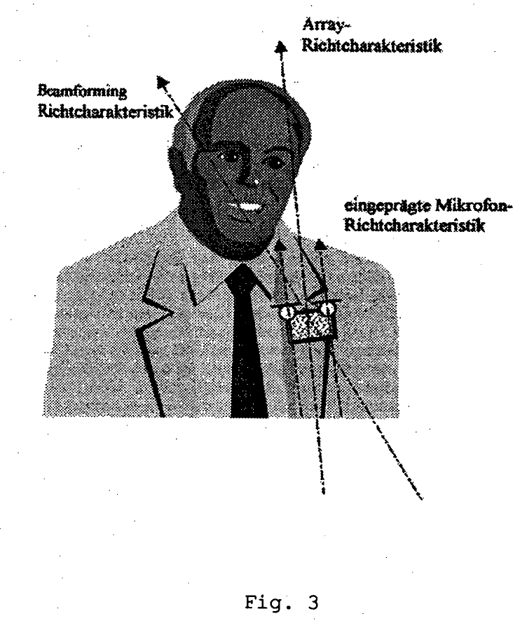

FIG. 3 shows the directional characteristic of the voice interface carried by the user

It is the object of the present invention to improve considerably ease of use and quality in the area of voice input systems. In all such implementations the user carries with him at all times a mobile voice interface with microphones, thus providing him with universal voice access to different systems. By using microphone arrays high input quality in the presence of noise can be achieved in different acoustic surroundings. Such a system is also suitable as a voice input system in vehicles since interference caused by noises due to the motion of the vehicle or by echo effects from loudspeaker outputs are attenuated by the microphone array. It is important that a voice interface which is to be worn constantly should be small and light and—depending on the external appearance—should be accepted as e.g. an ornament or an identification symbol.

FIG. 1 shows an overview of the cooperative voice input system components. The voice interface (2) is implemented as a mobile unit and is worn by the user, e.g. on his clothing. It transmits the acoustically recorded voice signals via a wireless link, e.g. an infrared or radio link, to the central unit (1), where the signals are processed further and diverse control functions are triggered.

To ensure a high quality of voice recording the voice interface (2) has two or more microphones (3a, 3b, 3c). Such an arrangement is shown magnified in FIG. 2.

The microphone used (3a, 3b, 3c) may have individual directional characteristics (cardioid, hypercardioid, figure of eight). With such a predefined microphone directional characteristic the sound within a particular zone is preferentially recorded and amplified.

The use of a small microphone system with two or more microphones suggested here according to the present invention permits the formation of microphone arrays. Due to the cooperation of the microphones in such a microphone array—and in conjunction with the electronic processing which is customary for such arrays—the quality of the voice input can be enhanced considerably: e.g. a special spatial directional effect of the microphone array—over and above the unchangeable microphone directional characteristic referred to previously—can be achieved, i.e. acoustic signals are preferentially recorded from a chosen spatial zone (the area of the user's mouth). As a result of this additional array directional characteristic, ambient noise from other surrounding areas is further suppressed or can be almost entirely filtered out electronically.

The array directional characteristic depends on the number and geometric arrangement of the microphones. In the simplest case two microphones are used (minimal configuration). Preferably, however, the interface is equipped with three (as shown in FIG. 2) or more microphones, which permit a better directional effect and better suppression of unwanted sounds. There are two fundamental microphone array arrangements: ‘broad-side’ and ‘end-fire’. With ‘broad-side’ the directional effect is perpendicular to the imaginary line connecting the microphones, with ‘end-fire’ the directional effect is in the same direction as the imaginary line connecting the microphones. The output signal of a ‘broad-side’ array is, in its simplest form, given by the sum of the individual signals, of an ‘end-fire’ array by the difference, propagation time corrections also being made.

The directional effect of the microphone array can be altered by further measures, thus making it possible to achieve an adaptive directional characteristic. Here the individual microphone signals are not simply added or subtracted but are evaluated by special signal processing algorithms in such a way that the acoustic signals are received more strongly from a main direction and ambient noise from other directions is recorded more weakly. The position of the main direction is adjustable, i.e. it can be matched adaptively to a changing acoustic scenario. The way in which the signal of the main direction is evaluated and maximized while noise from other directions is minimized can be specified in a error criterion. Algorithms for generating an adaptive directional effect are known under the name of ‘beam forming’. Widespread algorithms are e.g. the Jim Griffith beam former and the ‘Frost’ beam former.

By changing the appropriate parameters in the case of ‘beam forming’ the main direction can be varied in such a way that it coincides with the direction from which the words come, which is equivalent to an active speaker location. A simple way to determine the speech direction is e.g. to estimate the propagation time between two signals received from two microphones. If the cross-correlation between the two values is calculated, the maximum cross-correlation value for the propagation time shift of the two signals is obtained. If the appropriate signal is delayed by this propagation time, the two signals will be in phase again. As a result the main direction is adjusted to be coincident with the current speech direction. If the estimation of the propagation time and the correction are performed repeatedly, it is possible to keep constant track of the relative movement of the speaker. It is advantageous here to permit only one, previously specified, spatial sector for locating the speaker. This necessitates situating the microphone arrangement more or less in a particular direction relative to the speaker's mouth, e.g. on the speaker's clothing.

The speaker's mouth can then move freely within the specified spatial sector relative to the position of the voice interface (2)—the method for locating the speaker will keep track of such movements. If a signal source is detected outside the specified spatial sector, it will be identified as a disturbance (e.g. a loudspeaker output). The beam forming algorithm can now focus on the sound from this direction so as to minimize the strength of the disturbing signal. This also permits effective echo compensation.

FIG. 3 shows one possible arrangement, namely a small microphone system consisting of two single microphones with an impressed directional characteristic which is directed to the right of the speaker's mouth. The microphones are here located on the upper edge of a small case. The array type is ‘broad-side’, i.e. the directional effect of the array is oriented perpendicular to the edge of the case and upwards. The adaptive directional effect via beam-forming algorithms ensures that the effective directional characteristic is focused on the sound source, the speaker's mouth.

High-quality microphones are available in miniature format (down to millimetre size). Similarly, extremely compact wireless transmission devices, e.g. infrared or radio transmitters, can also be manufactured (as SMDs or ICs) with current technology. A small battery or accumulator (e.g. a button cell) suffices for the current supply since the energy consumption is very low. It is thus possible to Integrate all the components of the voice interface (2) to form a small unit which is also, because of the very low weight, comfortable to wear. For example, such a miniaturized voice interface (2) can be attached to the user's clothing by pinning it or as a clip (similar to a brooch) or can be carried on an arm band or necklace.

In a first embodiment the individual signals of the different microphones of the array are transferred to the central unit in parallel. These signals are there processed further electronically so as to adjust the directional characteristic and the noise suppression. Alternatively these functions can also be performed beforehand—at least partially—in the voice interface itself. In this case appropriate electronic circuits which provide initial signal processing are integrated in the voice interface (2). For example, the respective microphone recording level can be adjusted by automatic gain control or particular frequency components can be weakened or strengthened using appropriate filters.

As shown in FIG. 2, the input interface (2) can also include components for converting analog signals into digital signals. With the transmit/receive techniques available today the transmission of digital signals to the central unit (1) provides a very high information flow with minimum susceptibility.

The voice interface (2) can be provided with an activation key or sensor surface which, when actuated or touched, activates voice recognition, e.g. by transmitting an appropriate signal to the central unit (1). Alternatively, such activation may be effected by voice input of a key word.

In an expanded embodiment the voice input (2) also has a receiver (not shown) which can receive control signals communicated from the central unit (1) over a wireless link. The characteristic of the voice recording (combination of the microphones to an array, amplification, frequency filters, etc.) in the voice interface (2) can then be changed by the central unit (1). Furthermore, the central unit (1) can communicate an acoustic or optical signal to the user via the receiver, e.g. as ‘feedback’ for successfully triggered actions or also failed functions (command not recognized or—e.g. due to disturbance of the interfaces—a non-executable function) or to request further input (command incomplete). The signal transmitters can be integrated into the voice input interface (2), e.g. in the form of different coloured LEDs or piezoceramic miniature loudspeakers. There is also no reason why an input unit, e.g. a keyboard, for entering information in text form should not be provided.

The central unit (1) receives the wireless signals from the voice interface (2) and evaluates them for voice recognition. The various calculations needed locating the speaker and for adaptive matching of the directional characteristic of the microphone array can be performed in full or in part in the central unit (1). The processor power needed for reliable and fast signal processing and voice recognition can e.g. be provided via a standard computer/microprocessor system, this being preferably part of the central unit (1). Application-specific configurations (array characteristic, voice peculiarities, special switching/control commands, etc.) can then be reprogrammed at any time.

Since the central unit (1) is implemented as a stationary device separate from the voice interface (2)—e.g. integrated into other equipment (such as a television set, telephone system, PC system)—no particular problems or restrictions arise in connection with power supply, volume, weight or cooling of heat-producing components (processor) even for units designed for high performance electronically and as regards electronic data processing.

The central unit (1) is so configured that recognized commands trigger the appropriate switching and control functions, which various external appliances respond to, via integrated interfaces (4a, 4b, 4c).

Such appliances might be e.g. telephone systems, audio and video equipment, but also a plurality of electrically/electronically controllable household appliances (lights, heating, air conditioning, shutters, door openers, and many others). Correspondingly, when used in a vehicle, the vehicular functions (navigation system, music system, air conditioning, headlights, windscreen wipers, etc.) can be controlled.

The transmission of the control signals of the interfaces (4a, 4b, 4c) to the various external appliances can, in turn, be via a wireless link (IR, radio) or also (e.g. when used in a vehicle) by means of a cable connection.

The voice input device according to the present invention allows the user full freedom of movement (also over a wide area, e.g. different rooms/floors of a house). It is also very comfortable to wear since the voice interface (2) does not have to be attached to the head. Being so light and small (especially in its miniature embodiment) the voice interface constitutes no sort of impediment and can thus—similarly to a wristwatch—be worn for long periods.

Various appliances or functions at different locations can be controlled with one and the same voice interface (multimedia equipment, domestic appliances, vehicle functions, office PCs, security applications, etc.), since a number of central units at different locations (e.g. private rooms, vehicle, working area) can be adjusted so as to react in response to the same voice interface, i.e. the same user.

The high degree of flexibility of the voice input system which has been described is particularly advantageous. For example, the microphone array permits an active—depending on the particular embodiment also an automatic—adjustment to changing circumstances, e.g. different room acoustics or a change in the place on the user's clothing where the voice interface is attached (a different speech direction) or a new user (individual way of speaking). By programming the central unit the voice input system can be adapted flexibly to the respective control and regulation tasks.

Fundamentally the system according to the present invention offers the advantage that the very small and light voice interface can be worn permanently by the user. The user can continue to wear it without hindrance when he changes location, e.g. when he gets into his car. The microphone array and the associated directional effect of the sound recording ensure a high acoustic voice recording quality even in unfavourable circumstances (ambient noise). The complicated operations of voice processing can be effected by means of sufficiently powerful components in the central unit with a high certainty of recognition. The voice recognition can be adjusted individually for one or more users, e.g. so as to restrict a function to a predetermined authorized person or persons. Access to the various appliances via the relevant interfaces is freely configurable and can be modified and extended according to individual wishes for a wide variety of applications.

1. A voice input system comprising a stationary central unit (1) and a mobile voice interface (2), wherein the central unit (1) has means for receiving voice signals communicated via a wireless link and means for evaluating these voice signals to recognize spoken words, also interfaces (4a, 4b, 4c) which, depending on recognized words, generate switching or regulation signals which they transmit to external appliances, and wherein the voice interface (2) has two or more microphones (3a, 3b, 3c), which are combined to form a microphone array, and also means for the wireless transmission of the signals generated by the microphone array to the central unit (1).

2-12. (canceled)
